(19) United States
(12) Patent Application Publication
(10) Pub. No.: US 2007/0056089 A1
(43) Pub. Date: Mar. 15, 2007

(54) Shower pipe incorporating a two-way valve, and two way valve for a shower pipe

(76) Inventor: Hasnne Fentrouci, Renens (CH)

Correspondence Address: SUGHRUE MION, PLLC, 2100 PENNSYLVANIA AVENUE, N.W., SUITE 800, WASHINGTON, DC, 20037, US

(21) Appl. No.: 10/559,811

(22) PCT Filed: Jan. 11, 2002
(86) PCT No.: PCT/CH02/00018

§ 371 Date: Dec. 8, 2005

(51) Int. Cl. A47K 3/00

(52) U.S. Cl. 4/615

(57) ABSTRACT

The shower pipe comprises a flexible hose (2) connected to a two-way valve, which (comprises a body (3) inside which is accommodated a portion of a core (4) through which passes a longitudinal water passage (6). The valve comprises an actuating system (5) with a valve closure member, means (7) for guiding the actuating system in the core (4) and means (8) for returning the actuating system to a rest position. The actuating system (5) with the valve closure member is adapted to be moved in a direction (D) substantially perpendicular to the longitudinal axis of the passage (6) between a position of partial or complete closure with a portion of the system forming the valve closure member (5b) and a rest position. The actuating system (5) with the valve closure member further comprises an upper portion (5a) projecting out of the valve body (3). This upper portion (5a) is preferably rounded to allow movement of the system from the rest position to the position of partial or complete closure of the passage (6) when the valve is inserted into a housing of a wall-mounted showerhead holder whose shape is complementary to the exterior shape of the body (3) of the valve.

The invention relates to a shower pipe which comprises a two-way valve connected to a shower hose. The shower pipe is intended to be connected between domestic water supply means and a showerhead. The valve comprises a body inside which is accommodated a portion of a core through which passes a longitudinal water passage connecting the inlet and the outlet of the valve. The two-way valve is preferably at the showerhead end so that it can be inserted into a wall-mounted showerhead holder when the shower pipe is being used.

The invention also relates to a two-way valve for a shower pipe.

The two-way valve, which is preferably placed at one end of the shower hose, may be used to connect a showerhead. Its function is to interrupt the flow of water in the pipe partially or completely when a member for actuating the valve pushes a valve closure member into a position of partial or complete closure of the passage. It is therefore possible to save water when showering without having to operate the hot and cold taps or a lever of a domestic hot water supply mixer tap.

Several devices for saving water when showering have previously been proposed. In particular, providing a showerhead with a device for interrupting the flow of water is well known in the art. A member for actuating the device, taking the form of a lever or a button, for example, may be depressed on the showerhead by the hand of a user. If this member is not operated, the device interrupts the flow of water. Depressing this member allows water to pass through the showerhead. However, having to depress said member to open the interruption device while holding the showerhead in the hand possibly constitutes a drawback of a device of this kind.

The document EP 1 013 976 in the name of the Applicant proposes a shower pipe fitted with a two-way valve that is placed at the showerhead end of a shower hose. The valve comprises a body inside which is accommodated a portion of a core through which passes a longitudinal water passage. This valve comprises a valve closure member mounted to rotate inside the valve core and an actuating member connected to the valve closure member. The valve closure member is mounted to rotate in the core about an axis perpendicular to the direction of flow of the water. If the actuating member, which may be a rotary lever or a pushbutton, is not operated, the valve closure member is in a rest position that allows water to pass freely through the passage in the core. To interrupt the flow of water, the actuating member may be depressed or turned, a principle that is the opposite of that of the device described above. To depress or turn the actuating member, the valve body must be inserted into a housing of a wall-mounted showerhead holder with a shape complementary to that of said body. The valve closure member, entrained by the actuating member, turns in the passage about an axis perpendicular to the longitudinal axis of the passage in order to interrupt the flow of water in the passage partly or completely.

Because the valve closure member must be mounted inside the core in such a manner that it is able to turn about an axis perpendicular to the direction of flow of the water, several assembly operations are necessary. The core must in principle be in two parts. Initially, the valve closure member is placed inside the core. After this, the actuating member must be connected to said valve closure member either before or after assembling the two parts of the core. Finally, the core is inserted into the valve body with the valve closure member, the actuating member and the valve closure member return means.

A major drawback of the above type of shower pipe is that the valve requires the fabrication of a large number of components, necessitating the use of dedicated equipment. Various operations are also necessary to assemble said valve components, which complicates the production of this kind of shower pipe. Moreover, specific seals must be provided around the valve closure member and for the actuating member, which is a further problem. These special seals are difficult to place so that they assure a good seal for the valve, especially upon partial or complete closure of the passage. Because of this, the production costs of a shower pipe of this kind with a two-way valve are high.

Thus a main object of the invention is to alleviate the drawbacks of the prior art by proposing simple means for the partial or complete closure of a passage of the valve of a shower pipe when the valve is placed on a wall-mounted showerhead holder. Fabrication costs are greatly reduced and the valve comprises only a small number of components.

To this end, the invention consists in a shower pipe, as cited hereinabove, that is characterised in that the valve comprises at least one actuating system with a valve closure member, means for guiding the actuating system in the core of the valve and means for returning the actuating system to a rest position, the actuating system with a valve closure member being movable in a direction substantially perpendicular to the longitudinal axis of the passage between a partial or complete closure position in which a lower portion of the system forming the valve closure member closes the passage partly or completely and a rest position in which water may pass freely through the passage of the core between the inlet and the outlet of the valve, and in that the actuating system with a valve closure member has an upper portion projecting out of the valve body and conformed to allow displacement of the system from the rest position to the position of partial or complete closure of the passage when the valve is inserted into a housing of a wall-mounted showerhead holder having a shape complementary to the external shape of the valve body.

Also to this end, the invention further consists in a two-way valve for a shower pipe, an inlet of said valve being intended to be connected removably to a shower hose and an outlet of the valve being intended to be connected to a showerhead, said valve comprising a body inside which is accommodated a portion of a core through which passes a longitudinal water passage connecting the inlet and the outlet of the valve. The valve is characterised in that it comprises at least one actuating system with a valve closure member, means for guiding the actuating system in the core of the valve, and means for returning the actuating system to a rest position, the actuating system with a valve closure member being movable in a direction substantially perpendicular to the longitudinal axis of the passage between a position of partial or complete closure in which a lower portion of the system forming the valve closure member closes the passage partly or completely and a rest position in which water may pass freely through the passage of the core between the inlet and the outlet of the valve, and in that the actuating system with a valve closure member has an upper portion extending out of the valve body and conformed to allow the system to move from the rest position to the position of partial or complete closure of the passage when the valve is inserted into a housing of a wall-mounted showerhead holder having a shape complementary to the external shape of the valve body.

An advantage of the shower pipe and of the two-way valve according to the invention is that the valve actuating system with a valve closure member is easy to produce and to install in the guide means of the core of the valve. The actuating system, which may comprise a single component or several components nesting one within the other, is slid into the guide means of the core with the return means in a single operation. After this, the body may be fixed to the core in order to retain the actuating system with a valve closure member in the guide means. It is therefore not necessary to employ dedicated equipment for the fabrication of a shower pipe of this kind and its two-way valve, which greatly reduces fabrication costs.

Another advantage of the shower pipe and of the two-way valve according to the invention is that each actuating system with a valve closure member is moved in the guide means in a direction perpendicular to the direction of flow of water in the passage. Thus a simple O-ring placed in a circular groove of each system is sufficient to guarantee a good seal of the valve. The O-ring of each system is always in direct contact with a tubular surface of the guide means during movement of each actuating system with a valve closure member.

In an advantageous embodiment of the shower pipe and its valve, rotation of each system may be imposed when they move in a direction perpendicular to the longitudinal axis of the passage.

If the actuating system with a valve closure member is not operated, water may flow freely through the longitudinal passage of the valve. This flow is interrupted only when the body of the valve is inserted into a housing of a wall-mounted showerhead holder having a shape complementary to the external shape of the valve body. Because the upper portion of each system is preferably rounded, this facilitates the movement of each system into a position of partial or complete closure of the passage upon insertion into the housing of the wall-mounted showerhead holder.

As the shower pipe may be used in particular in hotels to save water when showering, it may be advantageous for the valve to be fixed to the hose in such a manner that it may not be demounted. In particular, this may prevent hotel guests stealing the two-way valve from the shower pipe. If the valve were used as a connector between the shower hose and the showerhead, it would of course be much easier to steal it.

The aims, advantages and features of the shower pipe and the two-way valve for the shower pipe will become more apparent in the course of the following description of embodiments shown in the drawings, in which:

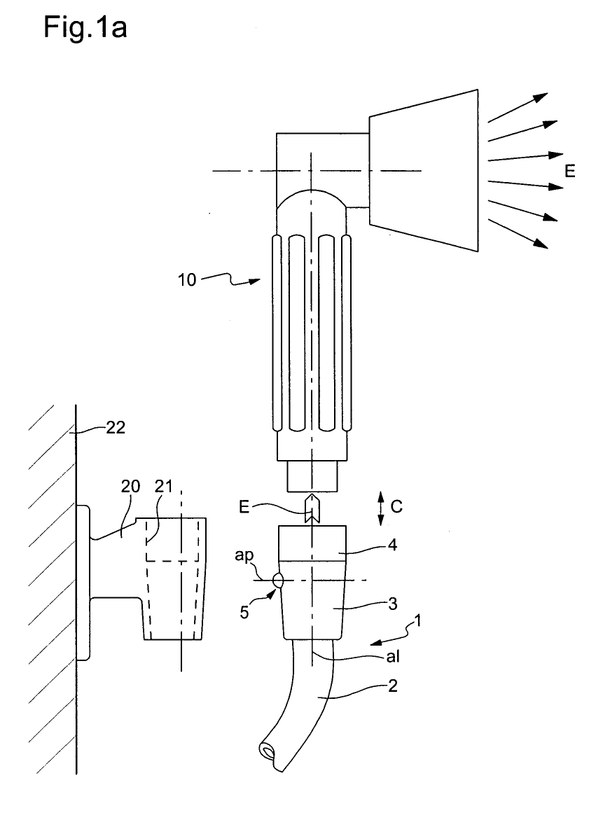

FIG. 1a is a view of a portion of a shower pipe according to the invention with a two-way valve for the connection to a showerhead, the valve being shown when taken out of a showerhead holder to allow water to flow through the showerhead,

FIG. 1b is a view of a portion of a shower pipe according to the invention whose two-way valve is shown when bearing on a wall-mounted showerhead holder in order to interrupt completely or partly the flow of water in the showerhead,

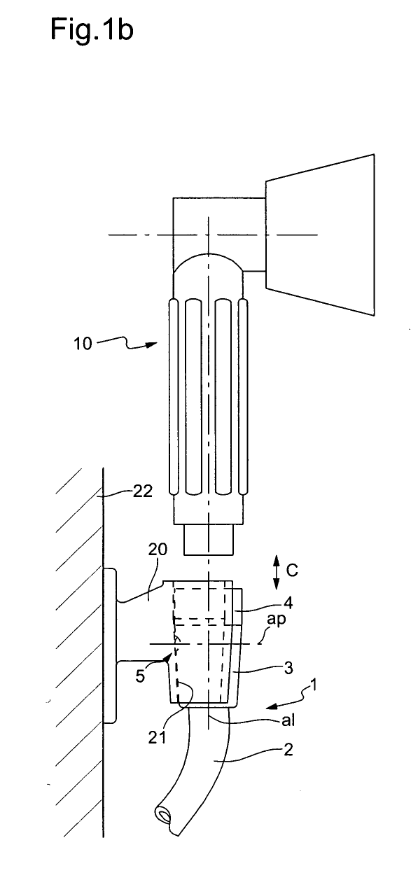

FIG. 2a shows in longitudinal section a first embodiment of one end of a shower pipe with a two-way valve according to the invention with an actuating system with a valve closure member, depicted in a rest position,

FIG. 2b shows in longitudinal section a first embodiment of one end of a shower pipe with a two-way valve according to the invention with an actuating system with a valve closure member, depicted in a position of partial or complete closure of the valve,

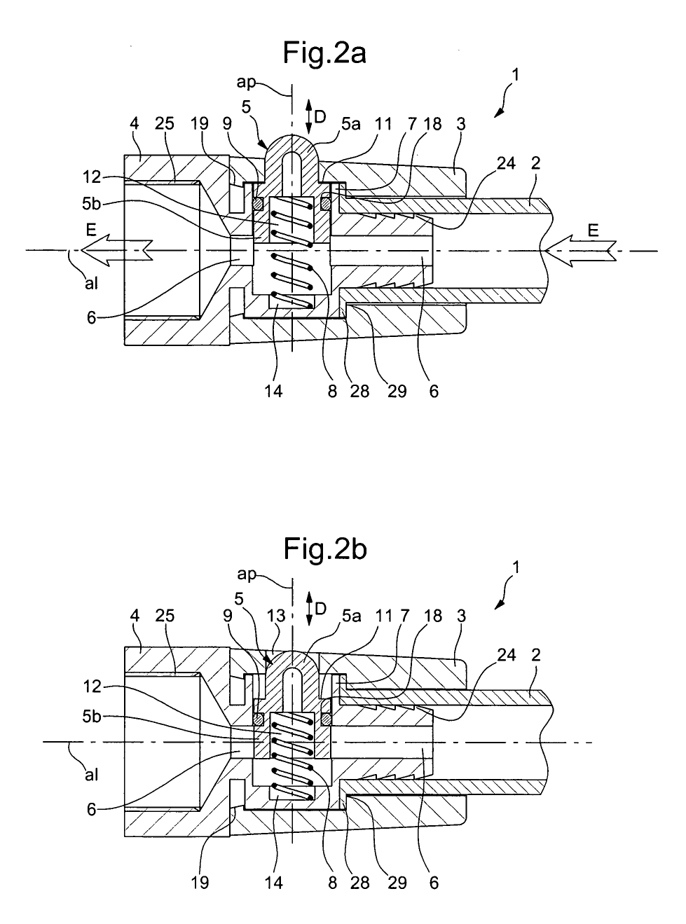

FIG. 3a shows in longitudinal section a second embodiment of one end of a shower pipe with a two-way valve according to the invention having two opposed actuating systems with valve closure member, depicted in a rest position,

FIG. 3b shows in longitudinal section a second embodiment of one end of a shower pipe with a two-way valve according to the invention having two opposed actuating systems with a valve closure member, depicted in a position of partial or complete closure of the valve,

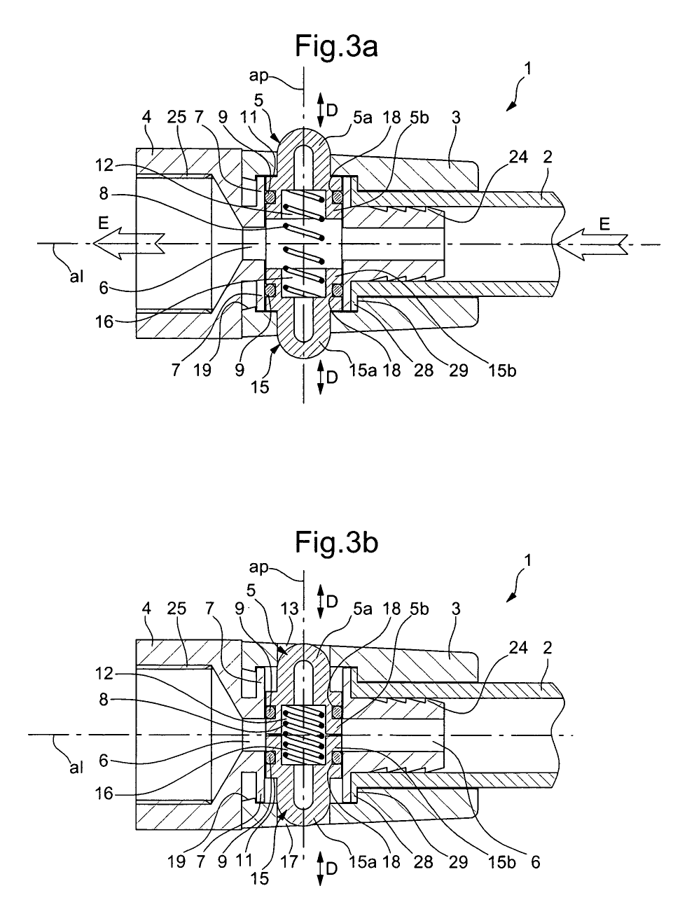

FIG. 4 shows in partial section a third embodiment of one end of a shower pipe with a two-way valve according to the invention that is demountable from the shower hose,

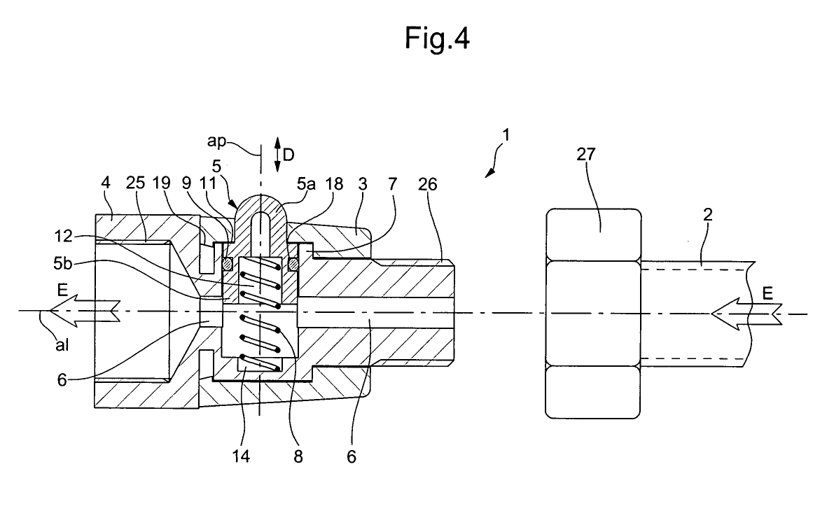

FIG. 5 shows in partial section a fourth embodiment of valve of a shower pipe according to the invention having at least one actuating system with a valve closure member, depicted in a position of partial or complete closure of the valve, and

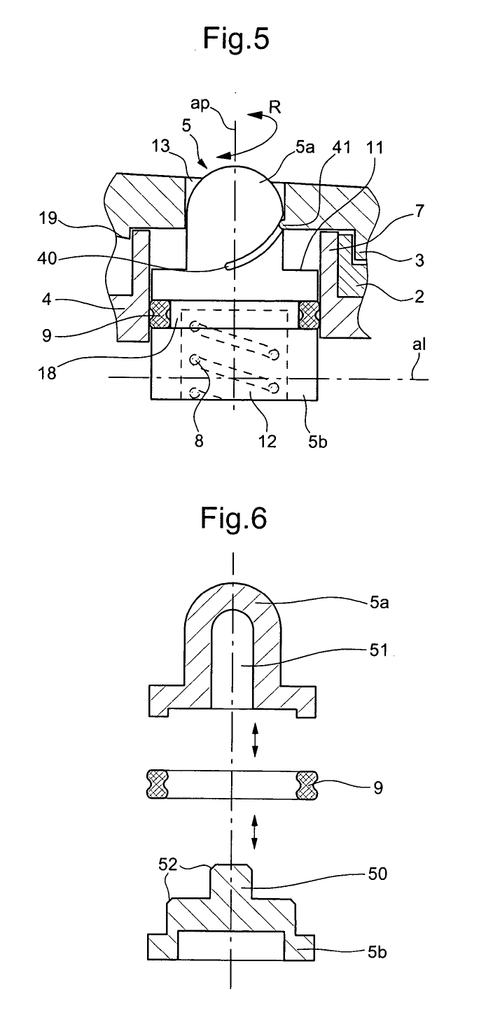

FIG. 6 is an exploded sectional view of one embodiment of an actuating system with a valve closure member having two parts or portions nesting one within the other to enclose an O-ring.

Referring to FIGS. 1a and 1b, the shower pipe 1 is shown in a simplified manner in a mode of use when showering. The showerhead 10, which must normally be connected to the end of the shower pipe 1, is shown separated from said end in the direction of the arrow C to show clearly the flow of water E at the outlet from the pipe 1 and the showerhead 10 in FIG. 1a.

The shower pipe 1 shown partially in FIGS. 1a and 1b comprises a conventional shower hose 2 connected to a two-way valve 3, 4 serving as a connector for the showerhead 10. The two-way valve comprises a core 4 partially accommodated in a body 3 and an actuating system 5 with a valve closure member. The actuating system 5 is adapted to be moved along an axis ap perpendicular to the longitudinal axis al of a water passage of the core 4. Only the upper portion of the system, which is preferably rounded, is depicted in FIGS. 1a and 1b. This upper portion serves as the actuating member of the actuating system with a valve closure member, while a lower portion that is not shown forms the valve closure member of the system.

In FIG. 1a, the end of the shower pipe 1 is shown when not inserted into an interior housing 21 of a holder 20 fixed to a wall 22 of a bathroom. Thus water may flow freely through the passage in the valve of the shower pipe 1 and the showerhead 10 held in the hand of the user because the actuating system 5 is in a rest position. Return means, not visible in FIGS. 1a and 1b, return the actuating system with a valve closure member to this rest position.

Note that the interior housing 21 of the holder 20 receiving the valve body 3 has a shape complementary to that of the exterior surface of the valve body. A longitudinal opening in the holder 20 must be wide enough for the hose 2 of the shower pipe to pass through it and to insert the valve body into the housing 21. This opening in the holder may be closed by a complementary component once the hose has been inserted via the opening into the housing 21. This variant of the showerhead holder with this additional component may be used in hotels anxious to save water, for example.

The exterior shape of the body 3 of the valve is preferably a truncated cone so that the valve may be inserted into and wedged in the housing 21 of the complementary shape wall-mounted showerhead holder 20. The external shape of the body 3 may also be that of a pyramid or any other shape, of course. However, the outside diameter of the body at the end connected to the shower hose 2 is less than the outside diameter of the body at the showerhead end. Thus the valve may easily be inserted into the housing 21 of the wall-mounted showerhead holder 20 and wedged therein by its own weight.

In FIG. 1b, the end of the shower hose is shown inserted into the housing 21 of the wall-mounted showerhead holder 20. The actuating system with a valve closure member 5 is moved against the action of the return means to a position of partial or complete closure of the passage of the valve. This interrupts the flow of water. The rounded shape of the upper portion of the system 5 facilitates movement of the system when the body 3 of the valve is inserted into the interior housing 21 of the wall-mounted showerhead holder.

FIGS. 2a and 2b show a first embodiment of the shower hose and the two-way valve in section. In FIG. 2a, the actuating system 5 with a valve closure member occupies a rest position allowing a flow E of water through the passage 6 of the core 4. In contrast, in FIG. 2b, the actuating system with a valve closure member 5 occupies a position of partial or complete closure of the passage 6. Of course, the movement of the actuating system with a valve closure member 5 in the direction D is obtained on inserting the valve body 3 into a wall-mounted showerhead holder. For simplicity, however, FIG. 2b shows only the state of the valve in the position of partial or complete closure of the passage 6.

The two-way valve comprises a core 4 partially accommodated inside a body 3. A longitudinal passage 6 in the core 4 enables water to flow between the inlet and the outlet of the valve when the actuating system with a valve closure member 5 is in a rest position.

Movement of the actuating system with a valve closure member 5 in a direction D perpendicular to the longitudinal axis al of the passage is guided by guide means 7. In this first embodiment, the guide means 7 comprise an open tubular portion of the core 4 leading from the passage 6 to an inside surface of the body 3. The inside guide surface of this tubular portion is preferably cylindrical, as is the exterior surface of the actuating system 5 guided in the tubular portion. However, it is obviously possible for the inside guide surface to be a tubular portion of polygonal section and likewise the guided exterior surface of the system. In this case, the actuating system with a valve closure member 5 is not able to turn inside the guide means 7, which is not important when the passage 6 is partially or completely closed.

To provide a good seal for the valve, a circular groove 18 is formed on the actuating system 5 with a valve closure member to accommodate an elastomer O-ring 9. The O-ring is always in contact with the interior guiding surface of the guide means 7 when the actuating system 5 moves between a rest position and a position of partial or complete closure of the passage 6. The O-ring 9 is situated between a lower portion 5b of the actuating system 5 forming a valve closure member and an upper portion 5a for actuating the system.

The upper portion 5a has a cross section smaller than that of the portion of the system guided by the guide means 7. In a rest position of the actuating system 5 with a valve closure member this rounded upper portion 5a projects out of the valve body 3 through an opening 13 in the body. It is connected by a rod of the same diameter to the guided portion of the system 5 through the opening 13 in the body 3. A shoulder 11 on the guided portion of the system abuts against an inside surface of the body 3 around the opening 13 in the rest position. Thus only the hemisphere of the upper portion 5a projects from the outside surface of the body 3, to serve as an actuating member of the system.

In this first embodiment, the upper portion 5a, the portion guided in the guide means 7, and the lower portion 5b forming the valve closure member constitute a single part. The O-ring 9 must be placed in the groove 18 on the actuating system 5 before inserting the system into the core 4.

Return means 8 are provided inside the core 4 to allow the actuating system 5 with a valve closure member to occupy a rest position in which it does not act on the upper portion 5a. The return means preferably comprise a helicoidal compression spring 8 crossing the passage 6 perpendicularly. The spring is preferably made of stainless steel. The spring 8 is held in a housing 14 of the core on the side of the passage 6 opposite the side accommodating the actuating system 5. A portion of the spring 8 is retained by accommodating it in an interior housing 12 of the actuating system 5.

When the components of the valve are assembled, a portion of the spring 8 is first placed in the housing in the actuating system with a valve closure member. After this step, the actuating system 5 is inserted with the spring 8 into the guide means 7 of the core until one end of the spring is accommodated in the housing 14 of the core 4. The spring is then compressed by depressing the system until the top of the upper portion 5a is flush with the opening at the top of the guide means 7. Finally, the body 3 covers the core and the upper portion 5a of the system passes through the opening 13 in the body. Because the spring 8 exerts a return force to return the system to the rest position, the shoulder 11 of the system abuts against an interior surface of the body 3.

In a variant that is not shown the return spring may be a tension spring fixed between the interior surface of the body 3 and the guided portion of the actuating system 5 with a valve closure member. Any other shape of spring may be used, of course, provided that the actuating system 5 is always in a rest position when it is not depressed. The return means may equally comprise only an inclined surface of the lower portion 5b of the actuating system 5, in which case the actuating system 5 is always urged towards its rest position by the force of the water flowing through the longitudinal passage 6.

At the end of the terminal portion 24, the passage 6 may have a rectangular cross section that, when the actuating system 5 returns from the position of partial or complete closure of the passage shown in FIG. 2b to the rest position shown in FIG. 2a, enables the water under pressure against the lower portion 5b of the system forming the valve closure member on closing the passage to assist the spring 8 to push the actuating system toward the rest position.

In this first embodiment, the end 28 of the shower hose 2 is held inside the valve against a bearing member 29 of the body 3 when the latter is fixed to the core 4 of the valve. In this way, the shower hose 2 is fixed to the two-way valve in such a way that it may not be demounted. The end 24 of the core, which is inserted inside the hose, may have peripheral ridges to retain the hose 2. The valve body 3 may be fixed to the core 4 by means of lugs 19 that clip over the guide means 7 of the core. Any other means of fixing the body 3 to the core 4 may be envisaged, of course.

The portion of the core 4 comprising the essential components of the valve described above is inside the body. On the other hand, the showerhead end of the core constitutes an external portion of the core. A rim of the external portion of the core 4 is pressed onto the neck of the body after inserting the core 4 into the body 3. The exterior end of said core 4 preferably comprises an inside screwthread 25 for screwing in a showerhead handle that is not visible in FIGS. 2a and 2b. Other connection means between the core 4 and the showerhead handle may be envisaged, however.

A second embodiment of the hose pipe and the two-way valve is shown in section in FIGS. 3a and 3b. For simplicity, only the components of the valve different from those described with reference to FIGS. 2a and 2b are explained. Note that components in FIGS. 3a and 3b that correspond to those in FIGS. 2a and 2b carry the same reference symbols. The shower hose 2 is fixed to the valve in such a manner that it may not be demounted, as in the first embodiment.

In FIG. 3a, the two actuating systems 5 and 15 with a valve closure member occupy a rest position that allows a flow E of water through the passage 6 of the core 4. The two actuating systems 5 and 15 face each other and are guided on two opposite sides of the passage 6 in the guide means 7 of the core 4. The interior surface of the guide means 7 is of tubular shape and open at both ends. This interior surface 7 may be cylindrical or polygonal, for example, like the guided exterior surface of each system 5 and 15. The longitudinal axes ap of the two portions of the guide means 7 are preferably coincident and perpendicular to the longitudinal axis al of the passage 6.

The helicoidal compression spring 8 has a first portion accommodated in a first interior housing 12 that is part of the first actuating system 5 with a valve closure member and a second portion accommodated in a second interior housing 16 that is part of the second actuating system 15. After assembling all the components of the valve, the upper portion 5a of the first system 5 passes through the opening 13 of the body 3 and the upper portion 15a of the second system 15 passes through an opposite opening 17 of the body 3. In the rest position, the shoulder 11 of each system 5 and 15 is pressed against an interior surface of the body around each opening 13 and 17 by the return force exerted by the compressed spring 8.

Note that for assembling the valve, the body 3 may be in two parts that are subsequently joined around the core to enclose the two actuating systems with a valve closure member in their guide means.

The valve closure member lower portions 5b and 15b of each system are smaller than the lower portion 5b described with reference to FIGS. 2a and 2b because each lower portion 5b and 15b must be able to move to a position in the vicinity of the centre of the passage when the passage is closed.

In FIG. 3b, the actuating systems 5 and 15 with a valve closure member occupy a position of partial or complete closure of the passage 6 with the two lower portions 5b and 15b able to come into contact with each other. Of course, the movement in the direction D of each actuating system 5 and 15 with a valve closure member is obtained when the body 3 of the valve is inserted into the wall-mounted showerhead holder.

The portion of the passage 6 at the end of the terminal part 24 may have a circular cross section so that, when the actuating systems 5 and 15 return from the position of partial or complete closure of the passage 6 to the rest position, the water under pressure against the valve closure member lower portions 5b and 15b of the systems on closure of the passage assists the spring 8 to push each actuating system 5 and 15 in the direction of the rest position.

FIG. 4 shows a third embodiment of the shower pipe and the two-way valve partly in section. The two-way valve is shown in a rest position of the actuating system with a valve closure member 5 allowing the flow E of water through the passage 6 of the core 4. The components constituting the valve are the same as those described with reference to FIGS. 2a and 2b and therefore carry the same reference signs.

The essential difference in this third embodiment is the means for fixing the two-way valve to the shower hose 2. A terminal portion of the core 4, projecting from the valve body 3 on the hose side, has a screwthread 26 on the exterior surface, for example. The nut 27 of a conventional shower hose 2 may therefore be screwed onto the threaded portion 26 of the core 4. The valve and the hose may be removably fixed in this way. Of course, this means of fixing the valve to the hose may also be used in an embodiment of the shower pipe similar to the second embodiment shown in FIGS. 3a and 3b.

In one variant of the fixing means, the end of the hose 2 may comprise an external screwthread so that it may be screwed into an internally screwthreaded portion of the valve body 3. Obviously any other fixing means for removably joining the valve to the shower hose may be envisaged.

FIG. 5 shows a fourth embodiment of the two-way valve based on the first, second or third embodiment shown in FIGS. 2 to 4. In FIG. 5, the actuating system 5 with a valve closure member is shown with a groove 40 formed on an actuating portion of the system. The groove 40 traces out a portion of a helix around the rotation axis ap of the actuating system 5. The opening 13 in the body 3 comprises a protuberance 41 accommodated in the groove 40. This imposes rotation R of the system 5 about its longitudinal axis ap on the occasion of its displacement D to close or open the passage of the valve. Of course, a slot could be provided in the opening 13 of the body co-operating with a projection tracing out a portion of a helix on the actuating portion of the system. Moreover, as explained with reference to FIGS. 3a and 3b, the actuating systems may each comprise a groove in which a protuberance at each opening of the body is guided for closing and opening the valve passage.

In all the embodiments described with reference to FIGS. 2 to 5, the upper portion, the portion guided in the guide means, and the valve closure member lower portion of each actuating system constitute a single part. However, to facilitate fitting the elastomer O-ring 9 into the circular groove 18 of each system, the actuating system may comprise two portions designed to nest one within the other. FIG. 6 is an exploded view in section of this kind of actuating system 5 with a valve closure member.

The actuating system with a valve closure member therefore comprises a first portion that consists of the valve closure member portion 5b and the O-ring 9 and a second portion that consists of the upper portion 5a serving as an actuating member of the system. After fitting the O-ring 9 to the first portion, a top portion 50 of the first part must be inserted, for example forcibly inserted, into a housing 51 of the second part. Bevels 52 are provided on the first part to facilitate the insertion of the top portion 50 into the housing 51 of the second portion.

The person skilled in the art may conceive of many variants of the shower pipe and the two-way valve described above that do not depart from the scope of the invention as defined by the claims. The body and the core of the valve, as well as the actuating system without the O-ring, may be made from plastics material or metal. The shape of the upper portion of each actuating system may be a truncated cone or pyramidal or any other shape. The upper portion must be easily depressed to assure partial or complete closure of the passage when the valve is inserted into the housing of the wall-mounted showerhead holder. The interior guiding surface of the guide means may also comprise a rectilinear projection co-operating with a groove in each system parallel to its longitudinal axis. This prevents rotation of each system when it moves in a direction perpendicular to the longitudinal axis of the passage of the core.

1-15. (canceled)

16. A shower pipe intended to be connected between domestic water supply means and a showerhead, said pipe comprising a shower hose connected to a two-way valve which comprises a body inside which is accommodated a portion of a core through which passes a longitudinal water passage connecting an inlet and an outlet of the valve, which valve comprises at least one actuating system with a valve closure member, means for guiding the actuating system in the core of the valve and means for returning the actuating system to a rest position, the actuating system with a valve closure member adapted to be moved in a direction substantially perpendicular to the longitudinal axis of the passage between a position of partial or complete closure, in which a lower portion of the system forming a valve closure member shuts off the passage partially or completely, and a rest position in which water may pass freely through the passage of the core between the inlet and the outlet of the valve, the actuating system with a valve closure member having an upper portion projecting out of the valve body and conformed to allow movement of the system from the rest position to the position of partial or complete closure of the passage when the valve is inserted into a housing of a wall-mounted showerhead holder whose shape is complementary to the exterior shape of the body of the valve, wherein the return means comprise an inclined surface of the valve closure member lower portion of the actuating system such that the actuating system is returned toward its rest position by the force of the water in the passage or by a spring crossing the passage perpendicularly and pressing the actuating system towards its rest position.

17. The shower pipe according to claim 16, wherein the return means comprise a spring crossing perpendicularly the longitudinal passage of a rectangular cross section, a first portion of the spring being placed in an interior housing of the actuating system and a second portion of said spring being placed in a housing of the core at the end of the passage opposite the actuating system.

18. The shower pipe according to claim 16, wherein the two-way valve comprises at least two actuating systems with a valve closure member disposed in the guide means of the core on two opposite sides of the passage, each valve closure member lower portion of one of the systems moving towards the other upon movement of each system into a position of partial or complete closure to shut off the longitudinal passage completely or partially.

19. The shower pipe according to claim 18, wherein the return means
comprise a spring crossing the longitudinal passage perpendicularly, a first portion of the spring being accommodated in a first interior housing of the first actuating system and a second portion of said spring being accommodated in a second interior housing of the second actuating system.

20. The shower pipe according to claim 16, wherein the guide means of the core are of tubular shape and extend from one end of the passage in the case of one actuating system or from two opposite ends of the passage in the case of two actuating systems, the longitudinal axis of the guide means being substantially perpendicular to the longitudinal axis of the passage, and wherein each actuating system comprises an O-ring disposed in a circular groove in an intermediate part of the actuating system, the O-ring being in contact with the tubular interior surface of the guide means.

21. A two-way valve for a shower pipe according to claim 16, an inlet of said valve being intended to be removably connected to the shower hose and an outlet of the valve being intended to be connected to a showerhead, said valve comprising a body inside which is accommodated a portion of a core through which passes a longitudinal water passage connecting the inlet and the outlet of the valve, which valve comprises at least one actuating system with a valve closure member, means for guiding the actuating system in the core of the valve, and return means for returning the actuating system to a rest position, the actuating system with a valve closure member being adapted to be moved in a direction substantially perpendicular to the longitudinal axis of the passage between a position of partial or complete closure, in which a valve closure member lower portion of the system shuts off the passage partly or completely, and a rest position, in which water may pass freely through the passage of the core between the inlet and the outlet of the valve, the actuating system with a valve closure member comprising an upper portion projecting out of the valve body and conformed to allow movement of the system from the rest position to the position of partial or complete closure of the passage when the valve is inserted in a housing of a wall-mounted showerhead holder of complementary shape to the exterior shape of the body of the valve, wherein the return means comprise an inclined surface of the valve closure member lower portion of the actuating system such that the actuating system is returned toward its rest position by the force of the water in the passage or by a spring crossing the passage perpendicularly and pressing the actuating system towards its rest position.

22. The valve according to claim 21, wherein the return means comprise a spring crossing perpendicularly the longitudinal passage of a rectangular cross section, a first portion of the spring being placed in an interior housing of the actuating system and a second portion of said spring being placed in a housing of the
core at the end of the passage opposite the actuating system.

23. The valve according to claim 21, wherein it comprises at least two actuating systems with a valve closure member disposed in the guide means of the core at two opposite ends of the passage and, upon movement of each system to a position of partial or complete closure, the valve closure member lower portions of the systems moving towards each other to close the longitudinal passage completely or partially.

24. The valve according to claim 23, wherein the return means comprise a spring crossing the longitudinal passage perpendicularly, a first portion of the spring being accommodated in a first interior housing of the first actuating system and a second portion of said spring being accommodated in a second interior housing of the second actuating system.

25. The valve according to claim 21, wherein the guide means of the core are of tubular shape and extend from one end of the passage in the case of one actuating system or from two opposite ends of the passage in the case of two actuating systems, the longitudinal axis of the guide means being substantially perpendicular to the longitudinal axis of the passage, and wherein each actuating system comprises an O-ring disposed in a circular groove on an intermediate portion of the actuating system and in contact with the tubular interior surface of the guide means.
